(19) United States
(12) Patent Application Publication
(10) Pub. No.: US 2019/0025450 A1
(43) Pub. Date: Jan. 24, 2019

(54) METHOD FOR USING VOXELATED X-RAY DATA TO ADAPTIVELY MODIFY ULTRASOUND INVERSION MODEL GEOMETRY DURING CEMENT EVALUATION

(71) Applicant: Philip Teague, Houston, TX (US)

(72) Inventor: Philip Teague, Houston, TX (US)

(21) Appl. No.: 16/139,783

(22) Filed: Sep. 24, 2018

Related U.S. Application Data
(60) Provisional application No. 62/561,739, filed on Sep. 22, 2017.

(51) Int. Cl. G01V 1/48; G01V 99/00; G01V 5/14; E21B 47/16; E21B 47/12; E21B 47/00

(52) U.S. Cl. CPC G01V 1/48; G01V 99/005; G01V 5/145; G01V 2200/16; E21B 47/123; E21B 47/0005; E21B 47/16

(57) ABSTRACT

A combining mechanism for borehole logging tool data that uses density data from a logging tool to inform the geometry of an acoustic-based or ultrasound-based data inversion is provided, comprising: at least one mechanism for converting three-dimensional density data into a three-dimensional density model; at least one mechanism for converting three-dimensional density model into a three-dimensional acoustic impedance model; and, at least one mechanism for processing acoustic data using said three-dimensional acoustic impedance model to produce an interpretable data log. A method of using density data from a logging tool to inform the geometry of an acoustic-based or ultrasound-based data inversion is also provided, comprising: converting three-dimensional density data into a three-dimensional density model; converting three-dimensional density model into a three-dimensional acoustic impedance model; and, processing acoustic data using said three-dimensional acoustic impedance model to produce an interpretable data log.

### TECHNICAL FIELD

The present invention relates generally to the monitoring and determination of cement integrity, zonal isolation and well integrity, within cemented single or multi-string wellbore environments, and in a particular though non-limiting embodiment to a method of using three-dimensional x-ray-based data and/or neutron porosity data to inform the inversion of ultrasound data collected from the same borehole.

### BACKGROUND

Within the oil & gas industry, the requirement to gauge the quality of cement through multiple casings is paramount as is the ability to determine the status of the annuli. The industry currently employs various methods for the verification of the hydraulic seal behind a single casing string. Typically, ultrasonic tools are run within the well to determine whether cement is bonded to the outside of the casing, thereby indicating the presence of cement in the annulus between the casing and formation, or between the casing and an outer casing. Ultimately, a leak-off (pressure) test is required to ensure that zonal isolation has been achieved as ultrasonic tools are highly dependent upon quality of the casing, the bond between the casing and the material in the annulus, and the mechanical properties of the material in the annulus to be able to work correctly. In addition, ultrasonic tools treat the material in the annulus as a single isotropic and homogenous volume, any actual deviation away from this ideal leads to inaccuracies in the measurement.

Cement bond logs (CBL) are still run today because they are relatively inexpensive and almost every wireline company has a version of the tool. The logs typically illustrate the use of the acoustic amplitude curve to indicate cement bond integrity. In a CBL log in well bonded cement, low amplitude generally indicates the presence of a good bond. Most logs run today have additional computed curves, as well as a Variable Density Log display of the acoustic waveforms.

The CBL uses conventional sonic log principals of refraction to make its measurements. The sound travels from the transmitter, through the mud, refracts along the casing-mud interface and then refracts back to the receivers. In fast formations (faster than the casing), the signal travels up the cement-formation interface, and arrives at the receiver before the casing refraction. The amplitude is typically recorded on the log in millivolts, or as attenuation in decibels/foot (db/ft), or as bond index, or any two or three of these. A travel time curve is also presented. It is used as a quality control curve. A straight line indicates no cycle skips or formation arrivals, so the amplitude value is reliable. Skips may indicate poor tool centralization or poor choice for the trigger threshold.

The actual value measured is the signal amplitude, measured in millivolts. Attenuation is calculated by the service company based on its tool design, casing diameter, and transmitter to receiver spacing.

Compressive strength of the cement is derived from the attenuation with a correction for casing thickness. Finally, bond index is calculated by the equation:

BI=A/Aₘₐₓ

Where:

A=Attenuation at any point on the log (db/ft)

Aₘₐₓ=Maximum attenuation (db/ft)

While the important results of a CBL are easily seen on a conventional CBL log display, such as signal amplitude, attenuation, bond index, and cement compressional strength, an additional display track is normally provided. This is the variable density display (VDL) of the acoustic waveforms, which provides a visual indication of free or bonded pipe (as do the previously mentioned curves) but also show the effects of fast formations, and decentralized pipe. The display is created by transforming the sonic waveform at every depth level to a series of white-grey-black shades that represent the amplitude of each peak and valley on the waveform. Zero amplitude is grey, negative amplitude is white, and positive amplitude is black. Intermediate amplitudes are illustrated as intermediate shades of grey.

The ultrasonic imaging technique produces acoustic borehole imaging logs. The ultrasonic imaging technique is a cased hole cement bond/cement mapping tool, but with more complete coverage of the borehole. This tool type is sometimes referred to as a rotating-head bond tool. In addition, precise acoustic measurements of the internal dimensions of the casing and of its thickness provide a map-like presentation of casing condition including internal and external damage or deformation. Rotating head ultrasonic (acoustic) imaging tools are the current state of the art for cement and casing integrity mapping. The typically tool sonde includes a rotating transducer subassembly available in different sizes to log all normal casing sizes. The direction of rotation of the subassembly controls the orientation of the transducer—counterclockwise for the standard measurement mode (so that the transducer facing is the casing or the borehole wall), and clockwise to turn the transducer 180 degrees within its subassembly (so that the transducer is facing a reflection plate within the tool) to measure downhole fluid properties. The fluid properties are used to correct the basic measurements for environmental conditions.

Analysis of the reflected ultrasonic waveforms provides information about the acoustic impedance of the material immediately behind the casing. A cement map presents a visual indicator of cement quality.

Current methods can offer information regarding the cement bond of the inner-most casing, yet do not have the ability to discriminate various depths into the cement or annular material. This can lead to the possibility that fluid-migration paths may exist at the cement-formation boundary, within the cement itself, or between the casing and an outer casing, thereby leading to a loss of zonal isolation. One reason for this is the use of a mathematical model, which describes mechanical properties (such as the speed of sound) associated with the material. Typically, however, these models are simplified and assume the casing is concentric and coaxial within the borehole (or other casings), and that the density of the material is homogeneous through the 360 degree azimuthal region of the cement/material in the annulus.

The use of the ultrasonic waveforms may be used to evaluate the quality of the cement or annular materials located between casing and a formation, or between the casing and a further casing. Further, ultrasonic logging may be used for flaw detection in the cement by determining whether material behind the casing is solid or fluid, based upon the time of arrival of reflected signals. A logging tool, which may have one or more ultrasonic transmitters and one or more ultrasonic receivers, is lowered into a wellbore and measurements are taken at various depths. Ultrasonic waves are transmitted from the logging tool towards the formation, and reflected from the casing, cement sheath, and formation. The reflected waves are received, recorded, processed, and interpreted to determine the presence, or lack thereof, of cement between the casing and the formation or other wellbore wall.

The ultrasonic waveform can then be used to evaluate the cement bond by determining the impedance of the material next to the casing itself. The impedance is a function of both bulk density and the speed of sound of the drilling fluid, casing, cement, and formation. The impedance is mathematically calculated using estimated properties of the casing, cement, mud and other materials in a complicated method requiring extensive knowledge of the well make-up for a particular well. Typically, the mathematical model assumes that the well casing is coaxial and concentric, and that the cement volume is complete (e.g., between the casing and formation, or between an outer casing and an inner casing) and the material homogenous. Any deviation from this ideal will form the basis for ‘interpreted anomalies’ within the cement. However, in practice, the casings are seldom perfectly coaxial and concentric, and the cement density varies anisotropically due to the uniformity of the lay-up and curing. As a result, the ultrasonic interpretation is inferred and based upon an idealized model, which, when compared to real-life geometries, lead to false positives that degrade the quality of the resulting interpretation.

Generally, traditional ultrasonic logging techniques can only provide the acoustic impedance of the material behind the casing. It is a challenge for ultrasonic logging to fully invert related important material properties, such as material velocity and density. Moreover, ultrasonic logging tools are not capable of discriminating the size of any gap or channel present in the cement volume. For example, a void between the casing and the cement sheath will give the same reading regardless of whether the void is a millimeter thick or several centimeters thick.

If a method could be established to determine the geometry of the materials in the annulus, then an adaptive ultrasound inversion model could be employed as function of depth. The inversion could then be adaptively modified such that the inversion is based upon an accurate geometry, and therefore, present a much more accurate interpretation of the result.

Prior art teaches a variety of techniques that use ultrasound, x-rays, neutrons or other radiant energy to inspect or obtain information about the structures within or surrounding the borehole of a water, oil or gas well, yet none teach of a method or means to use said x-ray and/or neutron porosity data to geometrically inform the inversion of ultrasound data, such that the quality of the result can be improved through implementation of an accurate three dimensional geometric model.

US2018/0180765 to Teague et al. teaches a method and means for improving the resolution and determination of the density of the materials surrounding a wellbore in a package that does not require direct physical contact with the well casings (i.e., non-padded). The invention comprises a method and means to use a pseudo-conical x-ray beam, located within a non-padded, concentrically-located borehole logging tool for the purpose of detecting density variations within the annular materials surrounding a borehole within single or multi-string cased-hole environments. The arrangement of the collimated detectors permits the collection of data that relates specifically to known azimuthal and radially located regions of interaction (azimuthally distributed depths of investigation). When the tool is moved axially within the well, a three-dimensional map of the densities of the annular materials surrounding the borehole is created such that variations in the density of the annular materials can be analyzed to look for issues with cement integrity and zonal isolation, such as channels, or holes in the annular materials that could transmit pressure.

US2018/0188411 to Teague et al. teaches methods and means for improving the resolution and determination of the density of the materials surrounding a wellbore, in a package requiring no direct physical contact with the well casings (i.e., non-padded). The method and means disclosed herein comprise using an actuated combination of collimators located cylindrically around an x-ray source, located within a non-padded concentrically-located borehole logging tool, for detecting density variations within the annular materials surrounding a borehole within single or multi-string cased-hole environments. The actuation of collimators permits the operator to choose between a fixed collimator mode in which the output is an azimuthal array of a plurality of x-ray beams, and an actuated collimator mode in which a single or plurality of individual azimuthally-arranged x-ray beams scan azimuthally through the rotation of one of the collimators. In addition, the actuation permits the operator to select a further non-rotating-mode in which the collimator sleeve switches among various angles or declinations of x-ray beam outputs with respect to the major axis of the tool.

U.S. Pat. No. 7,705,294 to Teague teaches an apparatus that measures backscattered x-rays from the inner layers of a borehole in selected radial directions, with the missing segment data being populated through movement of the apparatus through the borehole. The apparatus permits generation of data for a two-dimensional reconstruction of the well or borehole.

U.S. Pat. No. 9,817,152 to Soflienko et al. teaches a method and means to create a three-dimensional map of cement, casings and formation surrounding a cased borehole, using x-ray radiation to illuminate the casings, annular materials and formation. Further, it teaches a means for producing a voxelated map that contains axial, radial and azimuthal density variations, and thereby the geometry and form of the cement surrounding the cased hole.

WO2017/023282 to Zhang et al. discloses a method of using x-ray density data to determine the most probable attenuation properties of the material isotropically surrounding a cased wellbore, such that the speed of sound of the material can be used to inform the inversion of ultrasound data as a function of depth. The technique assumes that the x-ray density data provided for the cement, represented by a single azimuth (i.e., looking radially outward in one direction) is representative of the cement in all directions, and at all radial depths into the cement. As such, the technique only uses x-ray data to determine the cement density on the assumption that it is isotropic and homogenous, and that the casing itself is perfectly coaxial and concentric within the borehole and/or other casings.

WO2014/1866640 to Van et al. discloses methods and means for evaluating proper cement installation in a well. The method includes receiving acoustic cement evaluation data having a first parameterization. At least a portion of the entire acoustic cement evaluation data may be corrected to account for errors in the first parameterization, thereby obtaining corrected acoustic cement evaluation data. This corrected acoustic cement evaluation data may be processed with an initial solid-liquid-gas model before performing a posteriori refinement of the initial solid-liquid-gas model, thereby obtaining a refined solid-liquid-gas model. A well log track-indicating whether a material behind the casing is a solid, liquid, or gas may be generated by processing the corrected acoustic cement evaluation data using the refined solid-liquid-gas model.

US2014/0052376 to Guo et al. discloses a method for evaluating cement quality in a cased well. A single azimuth density log of the well is obtained using, for example, gamma ray sources and detectors. The detector count rates are inverted to provide initial estimates of cement density and thickness in a single azimuth. Acoustic waveform data are obtained from the well using an acoustic logging tool. The acoustic data are inverted, using the initial estimates of cement density and thickness obtained from the density logs wherein the model is assumed to be coaxial and homogeneous, and an updated density log is inferred. Cement ‘images’ are obtained from the updated density log, and cement bond quality can be estimated. It fails to teach of using x-ray data with azimuthal and radial resolution components to inform the variation in attenuation properties, as a function of volume, of the materials surrounding the cased borehole, It also fails to teach of a method or means to use said x-ray and/or neutron porosity data to inform the inversion of ultrasound data, such that the quality of the result can be improved through implementation of an accurate three dimensional geometric model.

U.S. Pat. No. 6,876,721 to Siddiqui discloses a method to correlate information taken from a core-sample with information from a borehole density log. The core-sample information is derived from a CT scan of the core-sample, whereby the x-ray source and detectors are located on the outside of the sample, and thereby configured as an outside-looking-in arrangement. Various kinds of information from the CT scan such as its bulk density is compared to and correlated with the log information.

U.S. Pat. No. 4,464,569 to Flaum discloses a method for determining the elemental composition of earth formations surrounding a well borehole by processing detected neutron capture gamma radiation emanating from the earth formation after neutron irradiation of the earth formation by a neutron spectroscopy logging tool.

U.S. Pat. No. 5,081,611 to Hornby discloses a method of back projection to determine acoustic physical parameters of the earth formation longitudinally along the borehole using a single ultrasonic transducer and a number of receivers, which are distributed along the primary axis of the tool.

U.S. Pat. No. 8,481,919 to Teague teaches of a method of producing Compton-spectrum radiation in a borehole without the use of radioactive isotopes, and further describes rotating collimators around a fixed source installed internally to the apparatus, but does not have solid-state detectors with collimators. It further teaches of the use of conical and radially symmetrical anode arrangements to permit the production of panoramic x-ray radiation.

US2013/0009049 to Smaardyk discloses an apparatus that allows measurement of backscattered x-rays from the inner layers of a borehole.

U.S. Pat. No. 8,138,471 to Shedlock discloses a scanning-beam apparatus based on an x-ray source, a rotatable x-ray beam collimator, and solid-state radiation detectors enabling the imaging of only the inner surfaces of borehole casings and pipelines.

U.S. Pat. No. 3,976,879 to Turcotte discloses a borehole logging tool that detects and records the backscattered radiation from the formation surrounding the borehole by means of a pulsed electromagnetic energy or photon source, so that characteristic information may be represented in an intensity versus depth plot format. The reference fails to teach of using x-ray data with azimuthal and radial resolution components to inform the variation in attenuation properties, as a function of volume, of the materials surrounding the cased borehole, It also fails to disclose a method or means to use the x-ray and/or neutron porosity data to inform the inversion of ultrasound data, such that the quality of the result can be improved through implementation of an accurate three-dimensional geometric model.

U.S. Pat. No. 4,883,956 to Manente et al. discloses an apparatus and methods for investigation of subsurface earth formations, using an apparatus adapted for movement through a borehole. Depending upon the formation characteristic or characteristics to be measured, the apparatus may include a natural or artificial radiation source for irradiating the formations with penetrating radiation such as gamma rays, x-rays or neutrons. The light produced by a scintillator in response to detected radiation is used to generate a signal representative of at least one characteristic of the radiation and this signal is recorded.

U.S. Pat. No. 6,078,867 to Plumb discloses a method for generating a three-dimensional graphical representation of a borehole, comprising the steps of: receiving caliper data relating to the borehole, generating a three-dimensional wire mesh model of the borehole from the caliper data, and color mapping the three-dimensional wire mesh model from the caliper data based on either borehole form, rugosity and/or lithology.

### SUMMARY

A combining mechanism for borehole logging tool data that uses density data from a logging tool to inform the geometry of an acoustic-based or ultrasound-based data inversion is provided, comprising: at least one mechanism for converting three-dimensional density data into a three-dimensional density model; at least one mechanism for converting three-dimensional density model into a three-dimensional acoustic impedance model; and, at least one mechanism for processing acoustic data using said three-dimensional acoustic impedance model to produce an interpretable data log.

A method of using density data from a logging tool to inform the geometry of an acoustic-based or ultrasound-based data inversion is also provided, comprising: converting three-dimensional density data into a three-dimensional density model; converting three-dimensional density model into a three-dimensional acoustic impedance model; and, processing acoustic data using said three-dimensional acoustic impedance model to produce an interpretable data log.

### BRIEF DESCRIPTION OF THE DRAWINGS

FIG. 1 illustrates an ultrasonic wellbore tool combined with an x-ray-based wellbore tool being lowered into a well by means of wireline conveyance, in addition to the cement masses surrounding the cased wellbore.

FIG. 2. illustrates one example of how ultrasound data is typically inverted based upon a highly homogeneous and radially symmetric model, to produce a data log or cement ‘image’.

FIG. 3 illustrates one example of how ultrasound data mat inverted based upon an adaptive model, the geometry of which has been informed by the three-dimensional cement density data provided by x-ray cement evaluation logs, to produce a more accurate data log or cement ‘image.’

### BRIEF DESCRIPTION OF SEVERAL EXAMPLE EMBODIMENTS

The methods described herein use the output of an x-ray-based borehole cement logging/mapping tool to inform the inversion model geometry used to invert the raw data collected by an acoustic/ultrasonic tool deployed to collect data within the same borehole.

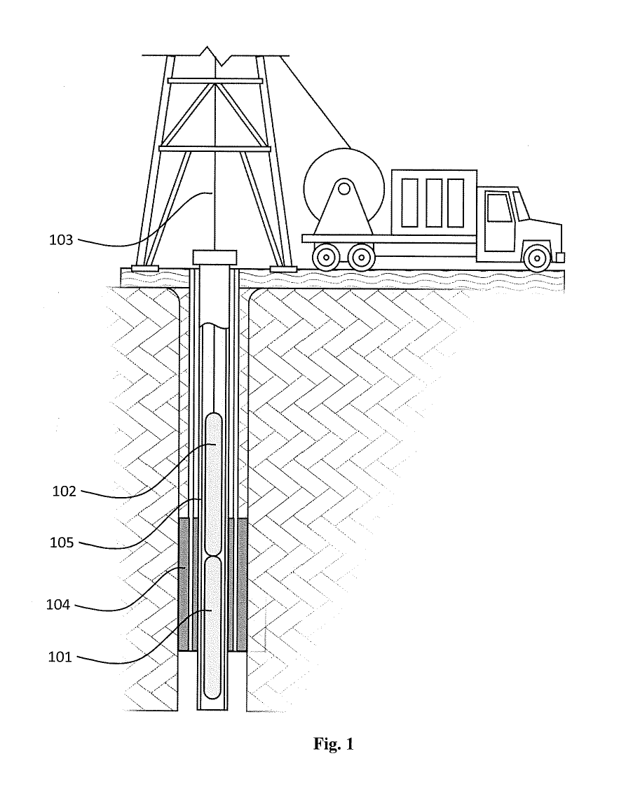

With reference now to FIG. 1, an example embodiment comprising an ultrasonic tool [101] is deployed into a borehole upon the same string as a x-ray-based cement evaluation tool [102], or a x-ray-based borehole mapping tool, or an isotope-based cement evaluation tool, or an isotope-based borehole mapping tool. The ultrasonic logging tool [101] is accompanied by an x-ray cement evaluation and/or neutron porosity tool [102] by wireline conveyance [103] into a cased borehole, wherein the cemented section of the well [104] is logged through the inner-most casing or tubing [105].

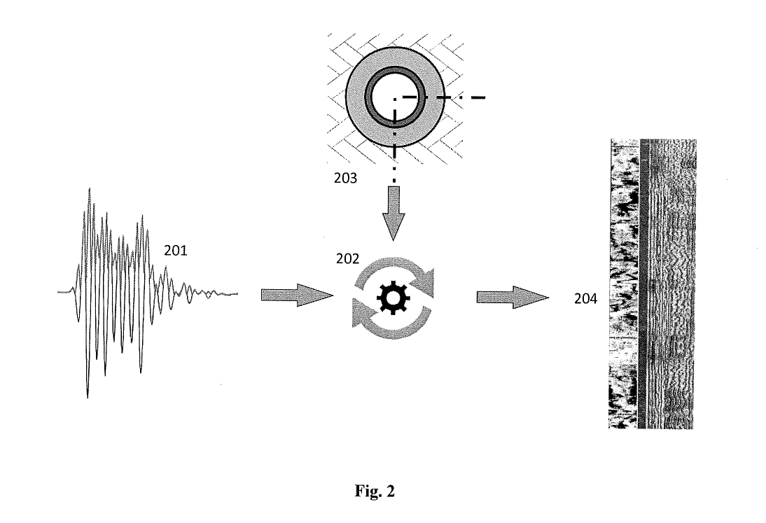

The example embodiment of FIG. 2 illustrates how during a typical ultrasound inversion, the raw ultrasound log data [201] is inverted and processed [202] through the use of a geometric model [203] which assumes the geometry of the casing, cement, and formation, along with their mechanical properties. The geometric model [203] is not adapted to the well geometry, such that the eccentricity of the casing, ovality of the casing, or ovality of the wellbore itself, as a function of depth, is not considered. The mechanical properties include acoustic impedance coefficients which are used the match the empirically) collected speed of sound (time of flight) data and signal attenuation, such that the actual mechanical properties of the cement can be determined to produce an image of cement homogeneity as a function of depth [204]. The output is typically represented as an ultrasonic image or variable density display [204].

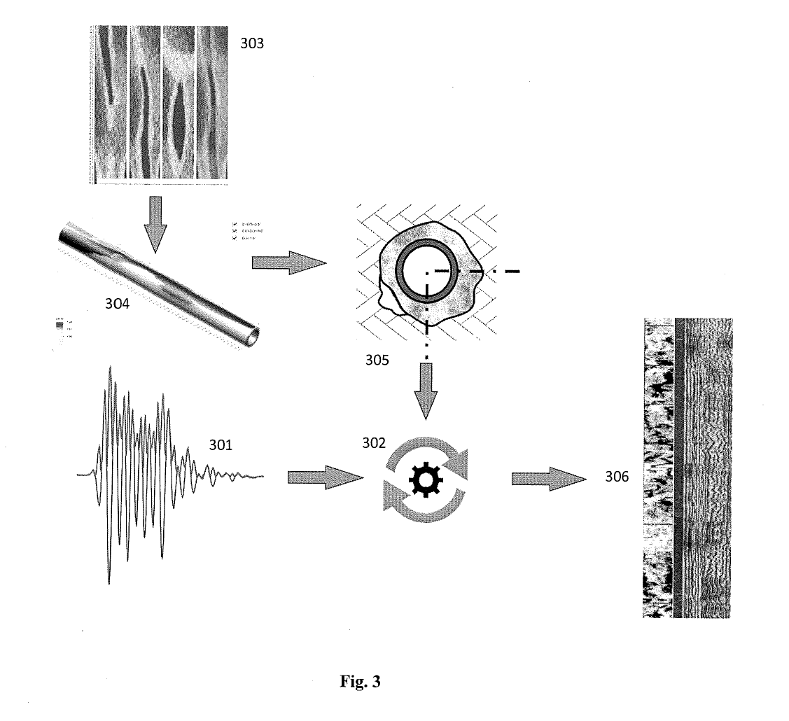

The example embodiment of FIG. 3 illustrates how raw ultrasound log data [301] may inverted and processed [302] through the use of a geometric model [305] which is unique for each depth interval (measurement according to logged depth). Three-dimensional x-ray density logs [303] are processed to create a voxelated three-dimensional density map of the cement as a function of depth [304]. The result is an accurate model including actual cement geometries, three-dimensional density variations, and any casing or formation eccentricities—which is computed for each depth interval. Acoustic impedance properties can be created from comparison with a database of known cement impedances for a known density, and the three-dimensional density model [305] reprocessed as necessary to create a three-dimensional model of acoustic impedance variations. As such, the model [305] which serves to inform the inversion [302] is based upon the physical geometries and attributes of the well that has been logged. The output is typically represented as an ultrasonic image or variable density display [306] that has now been corrected for wellbore geometry variations (as a function of depth) by use of the three-dimensional x-ray data.

In another embodiment, raw ultrasound log data [301] is inverted and processed [302] through the use of a geometric model [305] which is unique for each depth interval. Three-dimensional x-ray density logs [303] are processed along with neutron porosity logs to ensure that regions of the x-ray data which indicate a void or channel can be further corroborated by a relative increase in cement porosity (in the near-field region surrounding the casing). The three-dimensional x-ray density logs [303] once pre-processed to create a voxelated three-dimensional density map of the cement as a function of depth [304], are enhanced by the accuracy or confidence-interval of which has been improved dramatically by automated/processed comparison with neutron-porosity logs. The result is an accurate model including actual cement geometries, three-dimensional density variations (corroborated with porosity data), and any casing or formation eccentricities computed for each depth interval. Acoustic impedance properties can be created from comparison with a database of known cement impedances for a known density, and the three-dimensional density model [305] reprocessed as necessary to create a three-dimensional model of acoustic impedance variations. As such, the model [305] which serves to inform the inversion [302] is based upon the physical geometries and attributes of the well that has been logged. The output is typically represented as an ultrasonic image or variable density display [306].

In a further embodiment, machine learning can be employed to analyze the results of the inversion and quality index flags (produced from the inversion) to determine whether the selection of mechanical properties a specific cement depth interval was optimal, or whether the result would have a higher confidence level if an alternative set of cement characteristics had been used for the adaptive model.

In a further embodiment, machine learning can be employed to analyze the results of the inversion and quality index flags (produced from the inversion) to determine whether the three dimensional density model geometry adequately matches the anticipated results of the acoustic inversion—and to what degree other, alternative geometric model interpretations of the x-ray or neutron data would better fit the model behavior, thereby serving as an additional re-processing step for the ultrasound inversion.

In another embodiment, the data collected was from borehole tools deployed by wireline.

In a still further embodiment, the data collected was from borehole tools deployed by logging-while-drilling.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A combining mechanism for borehole logging tool data that uses density data from a logging tool to inform the geometry of an acoustic-based or ultrasound-based data inversion, comprising:
at least one mechanism for converting three-dimensional density data into a three-dimensional density model;
at least one mechanism for converting three-dimensional density model into a three-dimensional acoustic impedance model; and,
at least one mechanism for processing acoustic data using said three-dimensional acoustic impedance model to produce an interpretable data log.

2. The combining mechanism of claim 1, wherein said mechanism is configured to process ultrasound or acoustic data from a borehole logging tool.

3. The combining mechanism of claim 1, wherein said mechanism is configured to process x-ray data from a borehole logging tool.

4. The combining mechanism of claim 1, wherein said mechanism is configured to include the processing of neutron porosity data from a borehole logging tool to improve the accuracy of x-ray data from a borehole logging tool.

5. The combining mechanism for borehole logging tool data of claim 1, wherein said borehole tool is a wireline-based tool.

6. The combining mechanism for borehole logging tool data of claim 1, wherein said borehole tool is a logging-while-drilling-based tool.

7. The method of using density data from a logging tool to inform the geometry of an acoustic-based or ultrasound-based data inversion, comprising:
converting three-dimensional density data into a three-dimensional density model;
converting three-dimensional density model into a three-dimensional acoustic impedance model; and
processing acoustic data using said three-dimensional acoustic impedance model to produce an interpretable data log.

8. The method of claim 7, wherein said method processes ultrasound or acoustic data from a borehole logging tool.

9. The method of claim 7, wherein said method processes x-ray data from a borehole logging tool.

10. The method of claim 7, wherein said method further comprises the processing of neutron porosity data from a borehole logging tool to improve the accuracy of x-ray data from a borehole logging tool.

11. The method for borehole logging tool data of claim 7, wherein said borehole tool is a wireline-based tool.

12. The method for borehole logging tool data of claim 7, wherein said borehole tool is a logging-while-drilling-based tool.
